(19) United States
(12) Patent Application Publication
(10) Pub. No.: US 2025/0289339 A1
(43) Pub. Date: Sep. 18, 2025

(54) ELECTRIC VEHICLE CHARGING STATION

(71) Applicant: EV Buddy, Inc., Edison, NJ (US)

(72) Inventor: Suresh Arya, Edison, NJ (US)

(21) Appl. No.: 19/073,675

(22) Filed: Mar. 7, 2025

Related U.S. Application Data
(60) Provisional application No. 63/564,282, filed on Mar. 12, 2024.

(51) Int. Cl. B60L 53/63; B60L 53/65; B60L 53/66; B60L 53/68

(52) U.S. Cl. CPC B60L 53/63; B60L 53/65; B60L 53/665; B60L 53/68

(57) ABSTRACT

An Electric Vehicle (EV) charging station includes a charging apparatus providing electrical power to an electric vehicle (EV). The EV charging station may include a power panel having: load monitoring circuitry configured to measure a current load available at the power panel. Moreover, the device may include processor circuitry configured to: calculate a maximum power available for the charging apparatus, determine a margin of safety for charging the EV, where the margin of safety is at least one of user-configured parameters and dynamically calculated parameters based on an artificial intelligence (AI) model and machine learning (ML) algorithms, and adjust, in real-time, power supplied to the charging apparatus based on the measured current load and the determined margin of safety.

### CROSS-REFERENCE TO RELATED APPLICATION

This application claims the benefit of U.S. Provisional Patent Application No. 63/564,282, filed on Mar. 12, 2024. The entirety of this application is hereby incorporated by reference herein.

### FIELD

In some example embodiments, the subject matter herein generally relates to electric vehicle charging and more specifically to a charging station for electric vehicles.

### BACKGROUND

Electric Vehicles (EVs) include vehicles that utilize an electric motor alone as a drive source and hybrid electric vehicles (HEVs) that utilize an electric motor and a conventional internal combustion engine as a drive source. Both types of electric vehicles include an energy storage device, for example, a battery or a plurality of batteries that may be referred to as a traction battery to supply power to the electric motor. When the residual capacity of the battery decreases, the battery must be charged. In some HEVs, the battery may be charged by driving the vehicle, and some HEVs may also be charged by supplying power from an external power source. These may be referred to as a plug-in hybrid vehicle. Thus, EVs and plug-in HEVs generally require an external power source to charge the vehicle battery. In the following description reference to EV should be understood to include plug-in HEVs. In addition, reference to an EV battery should be understood to include a battery, battery pack, or traction battery.

An EV battery may be charged at a high-voltage DC charging station or via an Alternating Current (AC) power source using a home or business AC power outlet. Technological advancements in battery technology have extended the mileage range of EVs with some EVs having a range as high as 520 miles (836.9 km) before requiring a charge. The range, however, can be as low as 29 miles (46.7 km) in some EVs. While EVs are typically configured with a charge level indicator and range indicator, an operator of an EV may have to plan, in advance, where to charge their EV according to the distance between a starting location and a destination location.

Manufacturers of EVs and manufacturers of EV chargers continue to install EV charging stations in strategic locations in populated areas and along major thoroughfares. These charging stations may typically be high-voltage DC charging stations. EV manufacturers and other companies also offer home and business EV charging stations. These home and business EV charging stations may typically be powered by an Alternating Current (AC) power source including a home or business AC power outlet. A limit to the home and business EV charging stations is that the amount of electrical capacity is limited. While the number of EV charging stations continues to grow as more EV charging stations are deployed worldwide, the numbers are not yet comparable to conventional fuel stations. EV operators may have to alter their travel plans to find a location to charge their EVs.

The number and location of EV charging stations are a limitation to current EV owners and a concern to prospective EV consumers. This limitation is slowing the growth rate of EVs as current and prospective owners of EVs realize that charging their EVs is more challenging than refueling a gas-powered vehicle.

Thus, the need exists for a technological solution to alleviate the limitation in the number and location of EV charging stations.

The description provided in the background section should not be assumed to be prior art merely because it is mentioned in or associated with the back-ground section. The background section may include information that describes one or more aspects of the subject technology.

### SUMMARY

One of objects of the present disclosure is to provide a home or business EV charging station optimized to safely and efficiently provide EV charging as a commercial service.

A system of one or more computers or processing circuitry may be configured to perform particular operations or actions by virtue of having software, firmware, hardware, or a combination of them installed on the system that in operation causes or cause the system to perform the actions. One or more computer programs or sets of instructions can be configured to perform particular operations or actions by virtue of including instructions that, when executed by processing circuitry, cause the processing circuitry to perform the actions.

In one general aspect, an Electric Vehicle (EV) charging station may include a charging apparatus providing electrical power to an Electric Vehicle (EV). The EV charging station may include a power panel including: load monitoring circuitry configured to measure a current load available at the power panel. The power panel may include processor circuitry configured to: calculate a maximum power available for the charging apparatus, determine a margin of safety for charging the EV, where the margin of safety is at least one of user-configured parameters and dynamically calculated parameters based on an artificial intelligence (AI) model and machine learning (ML) algorithms, and adjust, in real-time, power supplied to the charging apparatus based on the measured current load and determined margin of safety. Other embodiments of this aspect include corresponding computer systems, apparatus, and computer programs recorded on one or more computer storage devices, each configured to perform the actions of the methods.

Implementations may include one or more of the following features. The EV charging station may include: a lighting device integrated with the charging apparatus; a video security apparatus integrated with the charging apparatus, the video security apparatus including a video capture device and a license plate reader, where the video security apparatus is configured to activate based on one or more predetermined conditions, an automated billing system configured to authorize a point-of-service transaction or charge a registered user's account based on a license plate identified by the license plate reader; and a communication device configured to transmit data collected by the video security apparatus and the automated billing system to a remote server. The EV charging station where the transmitted data includes: monitoring data, control data, and billing data, and where the automated billing system is configured to charge a registered user's account in a case where the license plate is verified by the video security apparatus. The EV charging station where the license plate reader is configured to authenticate the EV based on a database of authorized license plates before initiating a charging session, and where the automated billing system is further configured to initiate billing based on a duration and electricity consumption of an authenticated charging session. A PIN number is used for authentication for charging the EV, and is used for identifying an individual using the charging apparatus. The EV charging station where the lighting device is further configured to adjust illumination intensity based on ambient light conditions. The EV charging station where the video capture device is configured to start recording upon detection of motion within a predetermined range of the charging station and where recorded video is associated with a charging session for billing and security. The EV charging station where the recorded video is streamed live. The EV charging station where the AI model is configured to allocate a maximum unused power to the EV charging station and is trained based on peak power consumption patterns over specific time periods and make proactive adjustments to optimize a charging power available to the electric vehicle. The EV charging station where the AI model utilizes historical data selected from a group consisting a of time of day, a day of the week, and seasonal variations in power consumption, to predict optimal charging power and safety margins. The EV charging station may include a display panel and a user interface. The EV charging station where the processor circuitry is further configured to generate an alarm in a case where the safety margin exceeds a threshold. Implementations of the described techniques may include hardware, a method or process, or a computer tangible medium.

### DRAWINGS

FIG. 1 is a block diagram of an example EV charging system.

FIG. 2 is a flowchart showing processes according to some embodiments.

### EMBODIMENTS

The description of illustrative embodiments according to principles of the present disclosure is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the disclosure expressly should not be limited to such exemplary embodiments illustrating some possible non-limiting combination of features that may exist alone or in other combinations of features; the scope of the disclosed techniques, apparatus, and system being defined by the claims appended hereto.

This description is not intended to be understood in a limiting sense but provides an example of the technological solution presented solely for illustrative purposes by reference to the accompanying drawings to advise one of ordinary skill in the art of the advantages and construction of the technological solution. In the various views of the drawings, like reference characters designate like or similar parts.

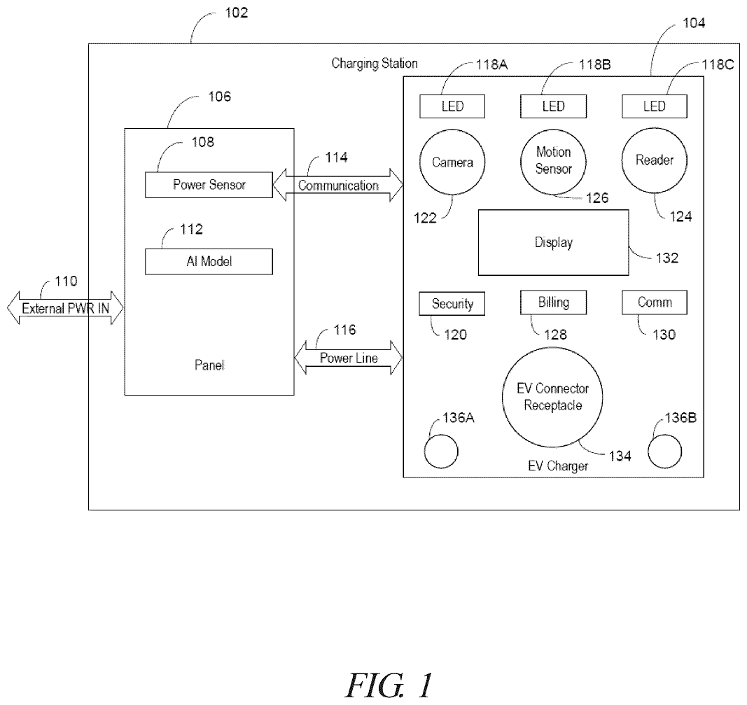

FIG. 1 is a block diagram of an EV charging station 102 may be an Electric Vehicle Supply Equipment (EVSE). EV charging station 102 may include power panel 106 coupled with EV charger 104. It should be understood that EV charger 104 may referred to as a charge point and also be referred to as an EVSE. Power panel 106 may be a main panel or a subpanel within charging station 102. It should be understood that the spacing between power panel 106 and EV charger 104 is for illustration only and is not intended to represent an actual physical relationship. Power panel 106 is connected to an external power source including storage battery system or solar (not shown) via power line 110. The external power source may be a 120-volt or 240-volt power source or DC power source such as battery storage or solar. The power supply or external power source may be a commercially supplied power source 3 phase 208/480 etc. 120-volt, 240-volt power source, or any commercially available power source. The power source may correspond with level 1, level 2, and level 3 chargers. Power panel 106 may include power sensor 108. Power panel 106 and EV charger 104 can be separate devices or combined in a single device.

Power sensor 108 includes load-monitoring circuitry (not shown). The load-monitoring circuitry may be configured to measure the current load available via external power line 110. Power sensor 108 may include processor circuitry (also not shown). Power sensor 108, may calculate the maximum power available for EV charger 104. In a home or business, the maximum power available for EV charger 104 may vary according to the amount of power available to the home or business and the amount of power being consumed by the home or business at any given time. For example, when a heating system or cooling system is running in the home or business, the power available via power line 110 is likely decreased. In addition, in some areas, the total amount of power available to a home or business may fluctuate according to the load on the serving (local) power grid. Thus, depending on the serving power grid, appliances, equipment, and the like, drawing electric power at the home or business, the power available to EV charger 104 may change or fluctuate at any given time or period. Unlike home or business EV chargers that have a static power setting, Power sensor 108 is configured to continuously monitor the amount of power available and calculate the maximum power available for the EV charger 104. Thus, optimizing available charging power and safety margins.

Power sensor 108 may be configured to determine a margin of safety for charging an EV. The margin of safety may be a user-configurable parameter, or the margin of safety may be dynamically calculated based on an artificial intelligence (AI) model and machine learning (ML) algorithms. It is noted that as used in this description at least one of A, B, and C means one of A or one of B or one of C, or any combination of A, B, and C. Thus, the statement at least one of user-configured parameters and an AI model and ML algorithms means one of the user-configured parameters, or one of an AI model, or one of ML algorithms, or any combination of user-configured parameters, an AI model, and ML algorithms. Processor circuitry of power sensor 108 may be configured to adjust in real-time the power supplied to EV charger 104 according to the measured current load and determined margin of safety. An AI model may implement ML algorithms in two phases, training and inference. In the training phase data is fed into the model so it may learn everything it can about the type of data analyzed. In the inference phase, the model may make predictions based on real-time data to produce actionable results. The AI model may also implement deep-learning algorithms. In deep learning, a deep neural network (DNN) may learn how to analyze a set of data and make predictions about the data. Deep learning relies on feedback so that the system learns from incorrect conclusions. The algorithm may access data from external sources, which include, for example, weather service and power supply companies.

The AI model may be configured to allocate to EV charger 104 a maximum amount of unused power available. The AI model may be trained according to peak power consumption patterns over specific periods and make proactive adjustments to optimize the charging power available to the EV charger 104 as well as a determined margin of safety.

Historical data may be an input to the AI model for training. Historical data may include power consumption based on a time of day, a day of the week, a week of the month, etc., and seasonal variations in power consumption. Seasonal variations in power consumption may be due to heating appliances operating in colder seasons and air conditioning appliances operating in warmer seasons. Seasonal variations impacting the local power grid may also be used to train the AI model.

In addition, the AI model may be trained by manually or automatically powering on and powering off electrically powered devices in the home or business one device at a time as well as powering on and powering off a combination of devices at the same time. The trained AI model may predict optimal charging power and safety margins.

Power panel 106 may be coupled with EV charger 104 via power line 116 and communication interface 114. Communication interface 114 may be wired, wireless, or a combination of wired and wireless. Power panel 106 provides power to EV charger 104 via power line 116. EV charger 104 may be coupled to an EV via EV receptacle 134.

EV receptacle 134 may include a fault detector and/or a self-test. The self-test may be configured to operate automatically or manually via display 132. In addition, the fault detector may be configured to operate automatically or manually via display 132. The self-test and fault detector circuits may include one or more sensors including temperature sensors and optical sensors. As part of the self-test and/or fault detector, EV receptacle 134 may be configured to perform high-voltage testing and circuit continuity testing. The self-test and/or fault detector of EV receptacle 134 may be configured to detect faults and potential issues with EV receptacle 134 contacts as well as faults and potential issues with the charging cable (not shown). There could be more than one EV receptacle 134 based on number of cables on the EVSE.

EV charger 104 may include a user interface and display 132. In addition, EV charger 104 may be configured to automate EV charging station 102 for a consumer. EV charger 104 may include LEDs 118A-118C, video camera 122, license plate reader 124, motion sensor 126, security apparatus 120, billing system 128, and communication interface 130.

Video camera 122 may be configured to begin recording upon detection of motion via motion detector 126. The sensitivity of motion detector 126 may be configured to detect motion within a predetermined range. Video camera 122 may provide a secure live stream of video to the owner or operator of charging station 102 via communication interface 130. Communication interface 130 may provide a secure wireless interface with an authenticated EV user, and communication interface 130 may provide a secure wireless interface with the owner or operator of charging station 102.

License plate reader 124 may be configured to authenticate an EV user attempting to use charging station 102 to charge an EV. License plate reader 124 may be coupled with a database of authorized license plates. This database may also include information linking a specific license plate with a specific EV (make, model, and color for example). That is, the database may be structured such that the EV user is authenticated when the authorized license plate matches the specific vehicle linked to the license plate in the database. In another aspect, authenticating the EV operator may be based on facial recognition according to video capture. Authenticating the EV operator may be any combination of authorized license plate matches to the EV, authorized license plate matches to the EV and the specific vehicle linked to the license plate in the database, and facial recognition according to video capture. In some embodiments, the system may have multiple personal identification number (PIN) numbers for respective members of a family or an office as an additional layer for protection. In some embodiments, the PIN numbers may be used for authentication for charging the EV, and may be used to identify the individual, in the family or the office, using the charging apparatus.

In addition, license plate reader 124 may be coupled to billing system 128. Billing system 128 may be configured to automatically initiate billing to the authenticated EV owner's account based on the duration and electricity consumption of the authenticated charging session. Billing system 128 may also be configured to accept a point-of-service transaction. In the case of a point-of-service transaction, an EV driver may use a credit card or other form of prepayment to purchase an amount of service from EV charging station 102. Point-of-service transactions may be performed via user interface and display 132.

EV charger 104 may include LEDs 118A-118C or a related light source. LED 118A-118C may be configured to illuminate charging station 102 and a predetermined area around charging station 102. LEDs 118A-118C may be configured to adjust the illumination intensity based on the ambient light conditions. In addition, video camera 122 may be configured with infrared for low light conditions.

Billing system 128, video camera 122, license plate reader 124, and communication interface 130 may each be a component of security apparatus 120. In some embodiments, security apparatus 120 may be a video security apparatus. Optionally each may be configured to operate through security apparatus 120. Thus, billing information, video recorded, license plate data, and related databases will remain secure.

Communication interface 130 may be a wired interface, a wireless interface, or a combination of wired and wireless interfaces. Communication interface 103 may be configured to transmit data secured through security apparatus 120 to a remote server. The secured data transmitted may include monitoring data, control data, and billing data. In addition, automated billing system 128 may configured to charge a registered user's account in a case where the license plate is verified by the security apparatus.

Charging station 102 may be configured with one or more processors in addition to the processor circuitry of power sensor 108. In addition, Charging station 102 may be configured with one or more speakers (not shown). Charging station 102 may be configured to generate an alarm in a case where the safety margin exceeds a threshold. Charging station 102 may be configured to generate an alarm in a case where the self-test or fault detector indicates an error. Charging station 102 may be configured to sound an audible alarm via one or more speakers, and to transmit an alarm to the owner or operator of charging station 102 via the communication interface 130. In addition, charging station 102 may be configured with one or power outlets 136A and 136B. Power outlets 136A or 136B may be used to supply power to one or more non-EV devices. For example, power outlet 136A may be used to power or charge a mobile device, tablet device, laptop computing device, or any device that may be connected to a conventional power outlet.

Charging station 102 may be deployed in a home, in a business, or at any property connected to a public power grid. The charging system described allows virtually any home, business, or property owner to deploy the charging station for personal use and is optimized to safely and efficiently provide EV charging as a commercial service. Accordingly, a homeowner, business owner, and the like may generate additional revenue by offering EV charging, and at the same time, help solve the limitation in the number and location of EV charging stations.

In another aspect, charging station 102 may be configured to allow emergency charging for a predetermined time or preset kilowatt-hour (kWh) adjustable via software. Charging station 102 may be configured with a configurable preset between charging sessions to prevent unauthorized or overuse of the charging service, and provide a benefit to drivers in a case of a loss or interruption of communication.

Charging station 102 may be configured to remotely control the power source or power outlets power providing power to power line 110. In addition, charging station 102 may be configured to individually meter the power provided to power line 110.

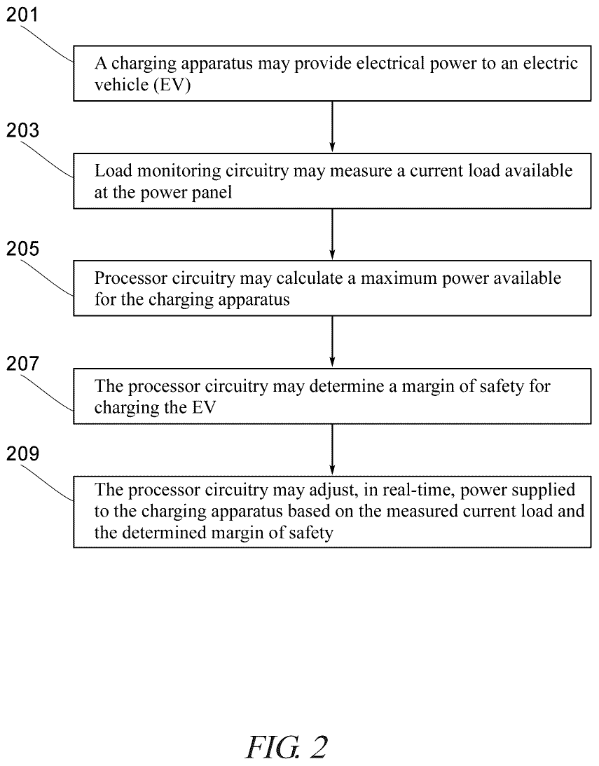

FIG. 2 is a flowchart showing processes according to some embodiments. In 201, a charging apparatus may provide electrical power to an electric vehicle (EV). In 203, load monitoring circuitry may measure a current load available at the power panel. In 205, processor circuitry may calculate a maximum power available for the charging apparatus. In 207, the processor circuitry may determine a margin of safety for charging the EV. In some embodiments, the margin of safety is at least one of user-configured parameters and dynamically calculated parameters based on an artificial intelligence (AI) model and machine learning (ML) algorithms. In 209, the processor circuitry may adjust, in real-time, power supplied to the charging apparatus based on the measured current load and the determined margin of safety. In some embodiments, the algorithm may access data from external sources, which include, for example, weather service and power supply companies.

Other variations to the disclosed embodiments can be understood and effected by those skilled in the art in practicing the recited features, from a study of the drawings, the disclosure, and the appended claims.

In the claims, the word “comprising” does not exclude other elements or steps, and the indefinite article “a” or “an” does not exclude a plurality.

A single processor, device or other unit may fulfill the functions of several items recited in the claims. The mere fact that certain measures are recited in mutually different dependent claims does not indicate that a combination of these measures cannot be used to advantage.

Operations like acquiring, accessing, analyzing, capturing, comparing, determining, inputting, obtaining, outputting, providing, store or storing, calculating, simulating, receiving, warning, and stopping can be implemented as program code means of a computer program and/or as dedicated hardware.

A computer program may be stored and/or distributed on a suitable medium, such as an optical storage medium or a solid-state medium, supplied together with or as part of other hardware, but may also be distributed in other forms, such as via the Internet or other wired or wireless telecommunication systems.

The methods according to the present disclosure may be implemented on a computer as a computer implemented method, or in dedicated hardware, or in a combination of both. Executable code for a method according to the present disclosure may be stored on a computer program product. Examples of computer program products include memory devices, optical storage devices, integrated circuits, servers, online software, etc. Preferably, the computer program product may include non-transitory program code stored on a computer readable medium for performing a method according to embodiments and equivalents, described herein, when said program product is executed on a computer. In an embodiment, the computer program may include computer program code adapted to perform all the steps of a method when the computer program is run on a computer. The computer program may be embodied on a computer readable medium.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An electric vehicle (EV) charging station, comprising:
a charging apparatus providing electrical power to an electric vehicle (EV);
a power panel comprising:
load monitoring circuitry configured to measure a current load available at the power panel; and
processor circuitry configured to:
calculate a maximum power available for the charging apparatus;
determine a margin of safety for charging the EV, wherein the margin of safety is at least one of user-configured parameters and dynamically calculated parameters based on an artificial intelligence (AI) model and machine learning (ML) algorithms; and
adjust, in real-time, power supplied to the charging apparatus based on the measured current load and the determined margin of safety.

2. The EV charging station according to claim 1, further comprising:
a lighting device integrated with the charging apparatus;
a video security apparatus integrated with the charging apparatus, the video security apparatus comprising:
a video capture device and a license plate reader, wherein the video security apparatus is configured to activate based on one or more predetermined conditions;
an automated billing system configured to authorize a point-of-service transaction or charge a registered user's account based on a license plate identified by the license plate reader, and
a communication device configured to transmit data collected by the video security apparatus and the automated billing system to a remote server.

3. The EV charging station according to claim 2, wherein the transmitted data includes: monitoring data, control data, and billing data, and wherein the automated billing system is configured to charge a registered user's account in a case where the license plate is verified by the video security apparatus.

4. The EV charging station according to claim 2, wherein the license plate reader is configured to authenticate the EV based on a database of authorized license plates before initiating a charging session, and wherein the automated billing system is further configured to initiate billing based on a duration and electricity consumption of an authenticated charging session.

5. The EV charging station according to claim 4, wherein a PIN number is used for authentication for charging the EV, and is used for identifying an individual using the charging apparatus.

6. The EV charging station of claim 2, wherein the lighting device is further configured to adjust illumination intensity based on ambient light conditions.

7. The EV charging station of claim 2, wherein the video capture device is configured to start recording upon detection of motion within a predetermined range of the charging station and wherein recorded video is associated with a charging session for billing and security.

8. The EV charging station of claim 7, wherein the recorded video is streamed live.

9. The EV charging station of claim 1, wherein the AI model is configured to allocate a maximum amount unused power to the EV charging station and is trained based on peak power consumption patterns over specific time periods and make proactive adjustments to optimize a charging power available to the electric vehicle.

10. The EV charging station of claim 9, wherein the AI model utilizes historical data selected from the group consisting of a time of day, day of week, and seasonal variations in power consumption, to predict optimal charging power and safety margins.

11. The EV charging station of claim 1, further comprising a display panel and a user interface.

12. The EV charging station of claim 1, wherein the processor circuitry is further configured to generate an alarm in a case where the safety margin exceeds a threshold.

13. The EV charging station of claim 2, wherein the video capture device and video security apparatus are configured to activate a charging session based on facial recognition.

14. The EV charging station of claim 2, further comprising one or more conventional power outlets.

15. A method comprising:
measuring a current load available at a power panel;
calculating a maximum power available for a charging apparatus;
determining a margin of safety for charging an electric vehicle (EV), wherein the margin of safety is at least one of user-configured parameters and dynamically calculated parameters based on an artificial intelligence (AI) model and machine learning (ML) algorithms; and
adjusting, in real-time, power supplied to the charging apparatus based on the measured current load and the determined margin of safety.

16. A non-transitory computer-readable medium for storing executable instructions, which cause a method to be performed, the method comprising:
measuring a current load available at a power panel;
calculating a maximum power available for a charging apparatus;
determining a margin of safety for charging an electric vehicle (EV), wherein the margin of safety is at least one of user-configured parameters and dynamically calculated parameters based on an artificial intelligence (AI) model and machine learning (ML) algorithms; and
adjusting, in real-time, power supplied to the charging apparatus based on the measured current load and the determined margin of safety.
